(19) United States
(12) Patent Application Publication
(10) Pub. No.: US 2026/0203265 A1
(43) Pub. Date: Jul. 16, 2026

(54) DATA ACCESSING METHOD AND DEVICE FOR INFLUXDB

(71) Applicant: SAMSUNG ELECTRONICS CO., LTD., Suwon-si (KR)

(72) Inventors: Hang LIU, Xi'an (CN); June LIU, Xi'an (CN); Baolian KANG, Xi'an (CN)

(73) Assignee: SAMSUNG ELECTRONICS CO., LTD., Suwon-si (KR)

(21) Appl. No.: 19/277,923

(22) Filed: Jul. 23, 2025

(30) Foreign Application Priority Data
Jan. 15, 2025 (CN) 202510065204.1

(51) Int. Cl. G06F 16/22; G06F 16/16; G06F 16/174

(52) U.S. Cl. CPC G06F 16/2228; G06F 16/162; G06F 16/1744

(57) ABSTRACT

A data accessing method for a time series database, includes: determining, by a host apparatus, whether a usage amount for a host memory exceeds a first threshold; and deleting, by the host apparatus, one or more in-memory indexes having an earliest time range in the host memory based on determining that the usage amount for the host memory exceeds the first threshold.

### CROSS-REFERENCE TO RELATED APPLICATIONS

This application is based on and claims priority under 35 U.S.C. § 119 to Chinese Patent Application No. 202510065204.1, filed on Jan. 15, 2025, in the China National Intellectual Property Administration, the disclosure of which is incorporated by reference herein in its entirety.

### BACKGROUND

### 1. Field

The present disclosure relates to the storage database technical field, and more specifically, to a data accessing method and device for InfluxDB.

### 2. Related Art

In order to solve a memory overflow problem for InfluxDB, the appearance time of memory overflow may be delayed by designing reasonable data structures (e.g., designing and optimizing data schemas such as tags, fields, and the like). However, this method relies on the skill of the designer, and cannot essentially eradicate the problem of memory overflow, which still occurs as the amount of data becomes larger with time.

Furthermore, the memory overflow may be prevented by persisting indexes on a disk and loading them into a host memory when the indexes are to be used. Although this method may solve the problem of memory overflow caused by excessive amount of index data, this method reduces data reading speed. Moreover, when a series file reaches a certain size, the indexes in the series file are traversed and loaded into the memory to be compacted, which also leads to the memory overflow if the base of the index data is very large.

Therefore, there is an urgent need for a method and device that can increase the data reading speed for the InfluxDB while preventing the memory overflow.

### SUMMARY

The purpose of the present disclosure is to provide a data accessing method and a device for InfluxDB to at least solve the problems described above in the related art, and any of the problems described above may not be solved.

According to an aspect of the disclosure, a data accessing method for a time series database, includes: determining, by a host apparatus, whether a usage amount for a host memory exceeds a first threshold; and deleting, by the host apparatus, one or more in-memory indexes having an earliest time range in the host memory based on determining that the usage amount for the host memory exceeds the first threshold.

According to an aspect of the disclosure, the data accessing method further includes: determining, by the host apparatus, whether one or more series indexes and one or more time series indexes (TSIs) corresponding to the one or more in-memory indexes exist in a disk based on determining, by the host apparatus, that the usage amount for the host memory exceeds the first threshold; and generating, by a Compute Express Link Processing-Near-Memory (CXL-PNM) circuit, the one or more series indexes and the one or more TSIs corresponding to the one or more in-memory indexes and storing the generated one or more series indexes and the one or more TSIs in the disk based on determining that the one or more series indexes and the one or more TSIs corresponding to the one or more in-memory indexes do not exist in the disk.

According to an aspect of the disclosure, the data accessing method further includes: determining, by the host apparatus, whether the usage amount for the host memory is less than a second threshold; and reloading, by the host apparatus, the one or more in-memory indexes that were recently deleted from the host memory into the host memory based on determining that the usage amount for the host memory is less than the second threshold, wherein the second threshold is greater than the first threshold.

According to an aspect of the disclosure, wherein the reloading of the one or more in-memory indexes that were recently deleted from the host memory into the host memory further includes: determining, by the host apparatus, a difference between a deletion time for the one or more in-memory indexes that were recently deleted from the host memory and a current time; and reloading, by the host apparatus, the one or more in-memory indexes that were recently deleted from the host memory into the host memory based on determining that the difference between the deletion time and the current time is greater than a third threshold.

According to an aspect of the disclosure, the data accessing method, further includes: rebuilding, by the host apparatus, one or more indexes of a current shard into the host memory and rebuilding one or more indexes of a non-current shard into a Computer Express Link (CXL) memory of the CXL-PNM circuit based on determining the time series database is restarted.

According to an aspect of the disclosure, the data accessing method, further including: performing, by the CXL-PNM circuit, compression of one or more time structured merge tree (TSM) files in the time series database based on determining a size of a respective TSM file exceeds a threshold.

According to an aspect of the disclosure, the performing of compressing the one or more TSM files by the CXL-PNM circuit includes: sending the one or more TSM files to a CXL memory of the CXL-PNM circuit by the host apparatus, performing compressing of the one or more TSM files in the CXL memory by a Processing-Near-Memory (PNM) engine of the CXL-PNM circuit; and storing the compressed one or more TSM files in a disk by the CXL-PNM circuit.

According to an aspect of the disclosure, wherein each shard in the time series database has a corresponding series file.

According to an aspect of the disclosure, the data accessing method further includes: sending a series file corresponding to the each shard to a CXL-PNM circuit by the host apparatus based on determining that a size of the series file corresponding to each shard exceeds a size threshold; and performing compression on the series file by the CXL-PNM circuit.

According to an aspect of the disclosure, the data accessing method further comprising: looking up an index corresponding to a read request for the time series database in the host memory in response to receiving the read request; looking up the index corresponding to the read request in a CXL memory of the CXL-PNM circuit based on determining that the index corresponding to the read request is not found in the host memory; and looking up data corresponding to the read request in the disk based on determining the index corresponding to the read request is not found in the CXL memory.

According to an aspect of the disclosure, the data accessing method, further comprising: storing the one or more series indexes and the one or more TSIs corresponding to the data in the CXL memory based on determining that the data corresponding to the read request is found in the disk.

According to an aspect of the disclosure, a data accessing device for a time series database, comprising: a memory configured to store one or more instructions; and a processor operatively coupled to the memory and configured to execute the one or more instructions stored in the memory, wherein the one or more instructions, when executed by the processor, cause the data accessing device to: determine whether a usage amount for a host memory exceeds a first threshold, and delete one or more in-memory indexes having an earliest time range in the host memory based on determining that the usage amount for the host memory exceeds the first threshold.

According to an aspect of disclosure, wherein the one or more instructions, when executed by the processor, cause the data accessing device to: whether one or more series indexes and one or more time series indexes (TSIs) corresponding to the one or more in-memory indexes exist in a disk based on determining that the usage amount for the host memory exceeds the first threshold, and generate the one or more series indexes and the one or more TSIs corresponding to the one or more in-memory indexes and store the generated one or more series indexes and the one or more TSIs in the disk based on determining that the one or more series indexes and the one or more TSIs corresponding to the one or more in-memory indexes do not exist in the disk.

According to an aspect of disclosure, wherein the one or more instructions, when executed by the processor, cause the data accessing device to: whether the usage amount for the host memory is less than a second threshold, and reload the one or more in-memory indexes that were recently deleted from the host memory into the host memory based on determining that the usage amount for the host memory is less than the second threshold, wherein the second threshold is greater than the first threshold.

According to an aspect of the disclosure, wherein the one or more instructions, when executed by the processor, cause the data accessing device to: determine a difference between a deletion time for the one or more in-memory indexes that were recently deleted from the host memory and a current time, and reload the one or more in-memory indexes that were recently deleted from the host memory into the host memory based on determining that the difference between the deletion time and the current time is greater than a third threshold.

According to an aspect of the disclosure, the data accessing device, wherein the one or more instructions, when executed by the processor, cause the data accessing device to: rebuild one or more indexes of a current shard into the host memory and rebuild one or more indexes of a non-current shard into a Computer Express Link (CXL) memory of a Computer Express Link Processing-Near-Memory (CXL-PNM) circuit based on determining the time series database is restarted.

According to an aspect of the disclosure, wherein the one or more instructions, when executed by the processor, cause the data accessing device to: perform compression of one or more time structured merge tree (TSM) files that need to be compacted in the time series database based on determining a size of the one or more TSM files exceeds a threshold.

According to an aspect of the disclosure, wherein the one or more instructions, when executed by the processor, cause the data accessing device to: send the one or more TSM files to the CXL memory of the CXL-PNM circuit, wherein the CXL-PNM circuit is configured to perform compression on the one or more TSM files in a CXL memory by a PNM engine of the CXL-PNM circuit, and store the compressed one or more TSM files in the disk.

According to an aspect of the disclosure, the data accessing device, wherein each shard in the time series database has a corresponding series file.

According to an aspect of the disclosure, wherein the one or more instructions, when executed by the processor, cause the data accessing device to: send a series file corresponding to the each shard to a CXL-PNM circuit based on determining that a size of the series file corresponding to each shard exceeds a size threshold, wherein the CXL-PNM circuit is configured to perform compression on the series file.

According to an aspect of the disclosure, wherein the one or more instructions, when executed by the processor, cause the data accessing device to: look up an index corresponding to a read request for the time series database in the host memory in response to receiving the read request; look up the index corresponding to the read request in a CXL memory of the CXL-PNM circuit based on determining that the index corresponding to the read request is not found in the host memory; and look up data corresponding to the read request in a disk based on determining that the index corresponding to the read request is not found in the CXL memory.

According to an aspect of the disclosure, wherein the one or more instructions, when executed by the processor, cause the data accessing device to: store the one or more series indexes and the one or more TSIs corresponding to the data in the CXL memory based on determining that the data corresponding to the read request is found in the disk.

According to an aspect of the disclosure, a non-transitory computer readable medium having instructions stored therein, which when executed by a processor, cause the processor to execute a method comprising: determining, by a host apparatus, whether a usage amount for a host memory exceeds a first threshold; and deleting, by the host apparatus, one or more in-memory indexes having an earliest time range in the host memory based on determining that the usage amount for the host memory exceeds the first threshold.

### BRIEF DESCRIPTION OF DRAWINGS

The above and other purposes and features of the present disclosure will become more apparent through the following descriptions made in conjunction with the figures schematically illustrating the embodiments, in which:

FIG. 1 illustrates a flowchart of a data accessing method for InfluxDB according to embodiments of the present disclosure;

FIG. 2 illustrates an overall schematic diagram of a data accessing method for InfluxDB according to embodiments of the present disclosure;

FIG. 3 illustrates a schematic diagram of performing compaction on a time-structured merge tree (TSM) file by a Compute Express Link Processing-Near-Memory (CXL-PNM) unit according to embodiments of the present disclosure;

FIG. 4 illustrates a flowchart of a process of reading data according to embodiments of the present disclosure; and

FIG. 5 illustrates a block diagram of a structure of a data accessing device for InfluxDB according to embodiments of the present disclosure.

FIG. 6 is a block diagram of an example computer system, in accordance with embodiments of the present disclosure.

### DETAILED DESCRIPTION

Hereinafter, various embodiments of the present disclosure are described with reference to the accompanying drawings, in which like reference numerals are used to depict the same or similar elements, features, and structures. However, the present disclosure is not intended to be limited by the various embodiments described herein to a specific embodiment and it is intended that the present disclosure covers all modifications, equivalents, and/or alternatives of the present disclosure, provided they come within the scope of the appended claims and their equivalents. The terms and words used in the following description and claims are not limited to their dictionary meanings, but, are merely used to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms include plural forms, unless the context clearly dictates otherwise. The terms “include,” “include,” and “have”, used herein, indicate disclosed functions, operations, or the existence of elements, but does not exclude other functions, operations, or elements.

For example, the expressions “A or B,” or “at least one of A and/or B” may indicate A and B, A, or B. For instance, the expression “A or B” or “at least one of A and/or B” may indicate (1) A, (2) B, or (3) both A and B.

In various embodiments of the present disclosure, it is intended that when a component (for example, a first component) is referred to as being “coupled” or “connected” with/to another component (for example, a second component), the component may be directly connected to the other component or may be connected through another component (for example, a third component). In contrast, when a component (for example, a first component) is referred to as being “directly coupled” or “directly connected” with/to another component (for example, a second component), another component (for example, a third component) does not exist between the component and the other component.

The expression “configured to”, used in describing various embodiments of the present disclosure, may be used interchangeably with expressions such as “suitable for,” “having the capacity to,” “designed to,” “adapted to,” “made to,” and “capable of”, for example, according to the situation. The term “configured to” may not necessarily indicate “specifically designed to” in terms of hardware. Instead, the expression “a device configured to” in some situations may indicate that the device and another device or part are “capable of.” For example, the expression “a processor configured to perform A, B, and C” may indicate a dedicated processor (for example, an embedded processor) for performing a corresponding operation or a general purpose processor (for example, a central processing unit (CPU) or an application processor (AP)) for performing corresponding operations by executing at least one software program stored in a memory device.

The terms used herein are to describe certain embodiments of the present disclosure, but are not intended to limit the scope of other embodiments. Unless otherwise indicated herein, all terms used herein, including technical or scientific terms, may have the same meanings that are generally understood by a person skilled in the art. In general, terms defined in a dictionary should be considered to have the same meanings as the contextual meanings in the related art, and, unless clearly defined herein, should not be understood differently or as having an excessively formal meaning. In any case, even terms defined in the present disclosure are not intended to be interpreted as excluding embodiments of the present disclosure.

The embodiments of the present disclosure refer to an InfluxDB. As understood by one of ordinary skill in the art, InfluxDB is an open-source time series database. The InfluxDB may be used for storage and retrieval of time series data in fields such as, for example, operations monitoring, application metrics, Internet of Things sensor data, and real-time analytics. As understood by one of ordinary skill in the art, the embodiments of the present disclosure are not limited to InfluxDB, and may include any suitable time series database known to one of ordinary skill in the art.

The InfluxDB may improve look-up performance by building indexes. There are two types of indexes which are in-memory indexes and time series indexes (TSIs) in the InfluxDB. The in-memory indexes are stored in the memory and may support series data in the level of ten millions. However, due to limited host memory resources, the indexes are mapped to disk files to generate TSIs in order to support series data in the level of hundred millions or billions.

In one or more examples, for ease of description, memory indexes are used interchangeably with in-memory indexes in the following.

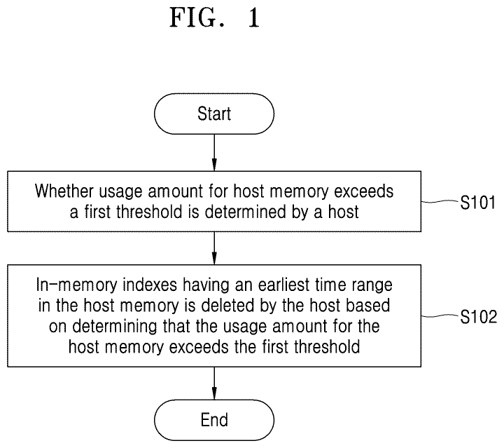

FIG. 1 illustrates a flowchart of a data accessing method for InfluxDB according to embodiments of the present disclosure.

Referring to FIG. 1, at operation S101, whether usage amount for a host memory exceeds a first threshold is determined by a host.

At operation S102, in-memory indexes having an earliest time range in the host memory are deleted by the host based on determining that the usage amount for the host memory exceeds the first threshold. In one or more examples, the usage amount of a memory may refer to amount of memory that is occupied by data. For example, if half of the memory is filled with data, the usage amount of the memory is 50%.

As understood by those skilled in the art, the in-memory indexes stored in the host memory correspond to shards in a disk. For example, a first in-memory index, a second in-memory index, and a third in-memory index in the host memory may correspond to a first shard, a second shard, and a third shard in the disk respectively, and if the third shard corresponds to a time range that is earlier than time ranges corresponding to the first shard and the second shard, the third in-memory index may be firstly deleted when the usage amount for the host memory exceeds the first threshold.

As understood by those skilled in the art, as the base of the series increases, the capacity of remaining available host memory is insufficient, thereby leading to a memory overflow problem. The remaining available host memory may be increased by deleting a portion of memory indexes in the host memory, thereby avoiding the host memory overflow.

In one or more examples, after deleting the memory indexes having the earliest time range, the remaining memory indexes in the host memory may continue to be deleted if the usage amount for the host memory still exceeds the first threshold or the usage amount for the host memory does not exceed the first threshold but exceeds a fourth threshold. That is, the memory indexes in the host memory may be deleted to ensure that the usage amount for the host memory is between the fourth threshold and the first threshold.

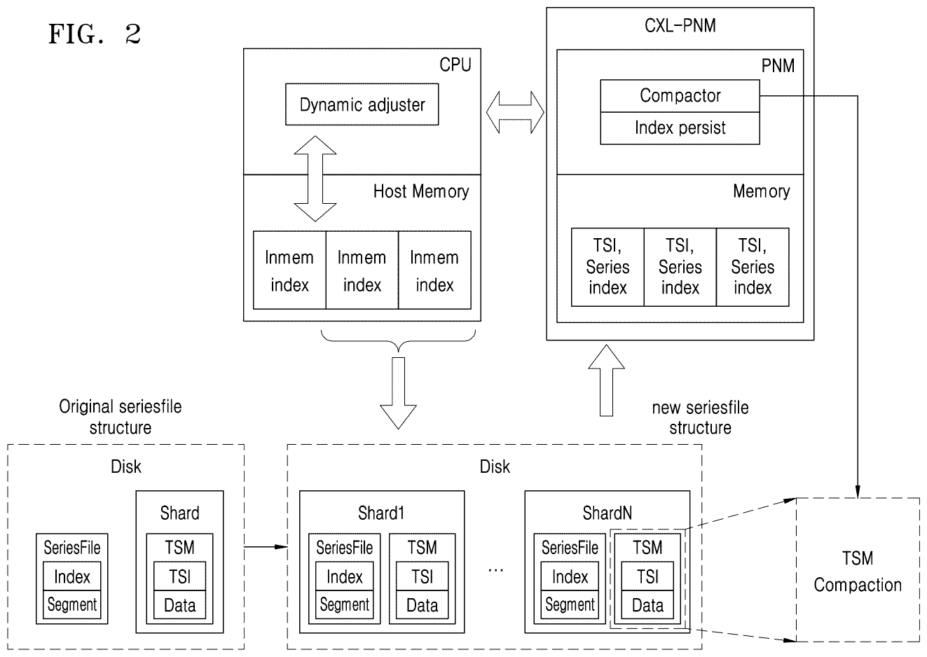

FIG. 2 illustrates an overall schematic diagram of a data accessing method for InfluxDB according to embodiments of the present disclosure.

Referring to FIG. 2, status of the host memory usage may be monitored to determine whether the usage amount for the host memory exceeds the first threshold by a dynamic adjuster.

In one or more examples, the dynamic adjuster may be executed in the host.

In one or more examples, the method illustrated in FIG. 1 may further include: determining, by the host, whether series indexes and time series indexes (TSIs) corresponding to the in-memory indexes exist in a disk based on determining that the usage amount for the host memory exceeds the first threshold; and generating, by a Compute Express Link Processing-Near-Memory (CXL-PNM) unit, the series indexes and the TSIs corresponding to the in-memory index and storing the generated series indexes and TSIs in the disk based on determining that the series indexes and the TSIs corresponding to the in-memory indexes do not exist in the disk. The CXL-PNM unit may be referred to as a CXL-PNM circuit. As understood by one of ordinary skill in the art, the CXL-PNM unit is a high-speed interconnect, industry-standard interface for communications between processors, accelerators, memory, storage, and other IO devices. CXL increases efficiency by allowing composability, scalability, and flexibility for heterogeneous and distributed compute architectures. CXL may maintain memory coherency between a CPU memory space and a memory on attached devices. CXL-PNM, in one or more examples, provides processing capabilities outside of the processor and near a memory module.

As understood by those skilled in the art, the series indexes indicates indexes in a series file stored in a shard and TSIs indicates indexes in a time-structured merge tree (TSM) file stored in the shard. In one or more examples, a TSM file may be a read-only file that is memory mapped. The TSM file may be composed of a (i) header, (ii) block, (iii) index, and a (iv) footer. The header may be a number to identify a file type and a version number. The blocks may be sequences of pairs of CRC32 checksums and data. The block data is opaque to the file. The CRC32 may be used for block level error detection. The length of the blocks is stored in the index. In one or more examples, following the blocks is the index for the blocks in the file. The index may be composed of a sequence of index entries ordered lexicographically by key and then by time. The key may include the measurement name, tag set, and one field. In one or more examples, there is one index block entry for each block in the TSM file that contains the key. The footer may store an offset of the start of the index.

As understood by those skilled in the art, the CXL-PNM unit may be a CXL-PNM card or a device or a unit based on CXL-PNM technology.

Referring to FIG. 2, the CXL-PNM unit may include a Compute Express Link (CXL) memory and a Processing-near-Memory (PNM) engine. The CXL memory may be used as an extension to the host memory.

Referring to FIG. 2, series indexes and TSIs corresponding to the memory indexes may be generated by an index persisting module in the CXL-PNM unit, and the generated series indexes and TSIs may be stored in the disk.

In one or more examples, the dynamic adjuster may also monitor the status of the PNM engine, and when it is determined that the PNM engine is in an idle state, a series file and a TSI file for a non-current shard may be generated by the PNM engine.

According to embodiments of the present disclosure, host CPU occupancy may be reduced by performing generation of series indexes and TSIs by the CXL-PNM unit.

In one or more examples, the method illustrated in FIG. 1 may further include: determining, by the host, whether the usage amount for the host memory is less than a second threshold; and reloading, by the host, in-memory indexes that were recently deleted from the host memory into the host memory based on determining that the usage amount for the host memory is less than the second threshold.

According to embodiments of the present disclosure, when the remaining available space of the host memory is large (e.g., remaining available space exceeds a threshold), reloading the recently deleted memory indexes into the host memory may enable frequently accessed data to be retained in the host memory as much as possible, thereby ensuring high-speed reading of hot data. In one or more examples, hot data may be data that is frequently accessed (e.g., data accessed a number times that exceeds a threshold within a time interval).

In one or more examples, the reloading of the in-memory indexes that were recently deleted from the host memory into the host memory includes: determining, by the host, a difference between a deletion time for the in-memory indexes that were recently deleted from the host memory and a current time; and reloading, by the host, the in-memory indexes that were recently deleted from the host memory into the host memory based on determining that the difference is greater than a third threshold.

In one or more examples, a counter may be utilized to determine whether a predetermined period of time has elapsed from deletion time of the most recently deleted memory indexes.

According to embodiments of the present disclosure, determining whether to rebuild the memory indexes based on the difference between the deletion time of the memory indexes and the current time may ensure that indexes that have just been offloaded will not be loaded into the host memory for a short period of time, thereby preventing frequent deleting and loading of the memory indexes corresponding to the same shard.

In one or more examples, the method illustrated in FIG. 1 may further include rebuilding, by the host, the indexes of a current shard into the host memory and rebuilding indexes of a non-current shard into a CXL memory of the CXL-PNM unit when the InfluxDB is restarted.

As understood by those skilled in the art, the InfluxDB may write data into a plurality of shards for storage based on saving time length of the data. For example, if the InfluxDB saves data within one week, each shard may save data for single day, and the data currently written may be put into the current shard, and data for the next day may be written to a second shard, and so on.

If the InfluxDB service is restarted, it will determine whether a shard for writing at the current time is a new shard or a previously existing shard. Specifically, if the current time has not yet exceeded time range of existing shards, the data may be written to the newest shard among shards that already exist, and if the current time has exceeded the time range of the newest shard, a new shard will be created to be used for the data writing. Shards for non-current writing are non-current shards.

In other words, the current shard indicates a shard for which the current write is, and the non-current shards indicate other shards stored in the InfluxDB.

As understood by those skilled in the art, the compaction of TSM files in the related art is performed by the host, which increases the CPU and IO load for a short period of time and duration of time varies according to the size of data. During the compaction (e.g., compression), the writing and reading speed of the database may be significantly impacted.

In one or more examples, compaction on TSM files that need to be compacted in the InfluxDB is performed by the CXL-PNM unit, when the TSM files needs to be compacted. In one or more examples, it is determined that a TSM file needs to be compacted (e.g., compressed) if a size of the TSM file exceeds a size threshold.

In one or more examples, the performing of compaction on the TSM files that need to be compacted by the CXL-PNM unit includes: sending the TSM files to the CXL memory of the CXL-PNM by the host, performing compaction on the TSM files in the CXL memory by a PNM engine of the CXL-PNM unit, and storing the compacted TSM files in the disk by the CXL-PNM unit.

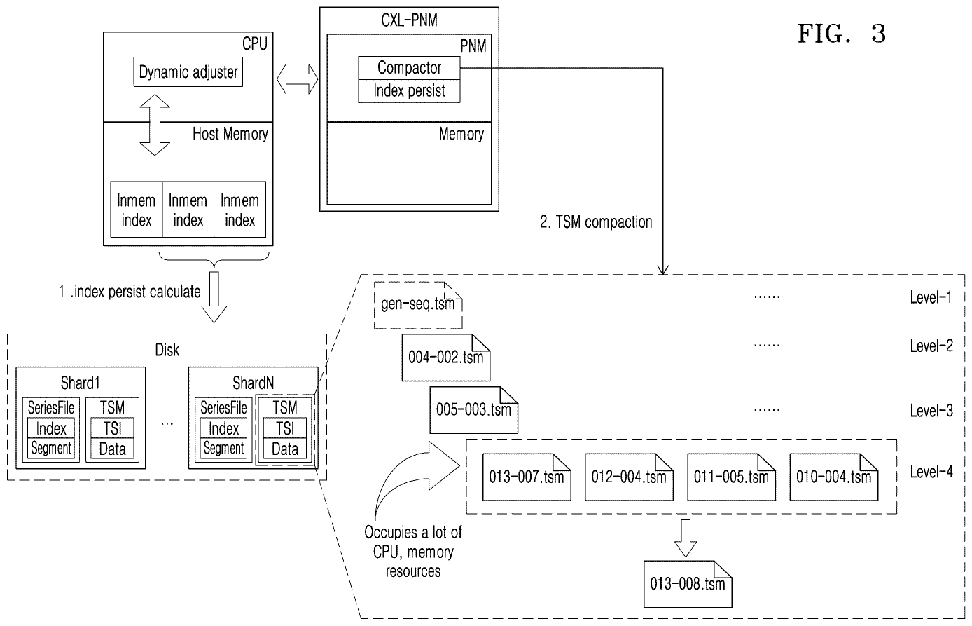

FIG. 3 illustrates a schematic diagram of compaction of a TSM file performed by a CXL-PNM unit according to embodiments of the present disclosure.

Referring to FIG. 3, when a TSM file in the Nth shard triggers the compaction, data in the TSM file may be loaded into the CXL memory and the compaction on the data in the TSM file may be performed by, for example, a compactor in the CXL-PNM unit.

According to embodiments of the present disclosure, the CPU occupancy may be reduced and the cost of data transfer between the CPU and the memory may be reduced by performing the compaction (e.g., compression) on the TSM file via the CXL-PNM unit.

In one or more examples, each shard in the InfluxDB has a corresponding Series File.

In one or more examples, in the process of storing data, the series file may be generated according to the shards.

As understood by those skilled in the art, with reference to FIG. 2, all the shards correspond to one series file in the prior art, while according to embodiments of the present disclosure, each shard has a corresponding series file. For example, N shards correspond to one series file in the prior art. In contrast, according to embodiments of the present disclosure, the N shards correspond to N series files. For example, each shard has its own shard.

As the series file grows larger, the series file may also need to be compacted.

In one or more examples, the method illustrated in FIG. 1 may further include: sending a series file corresponding to the each shard to a CXL-PNM unit by the host based on determining that the series file corresponding to the each shard needs to be compacted, and performing compaction on the series file by the CXL-PNM unit.

According to embodiments of the present disclosure, the data amount of the series file at the shard level is less than the data amount of the series file at the database level, and therefore, a large amount of resource occupancy and/or memory overflow may be avoided by performing compaction of the series file via the host or the CXL-PNM unit.

In one or more examples, the method illustrated in FIG. 1 may further include: looking up an index corresponding to a read request for the InfluxDB in the host memory in response to receiving the read request; looking up the index corresponding to the read request in a CXL memory of the CXL-PNM unit based on the index corresponding to the read request being not found in the host memory; and looking up data corresponding to the read request in the disk based on the index corresponding to the read being not found request in the CXL memory.

In one or more examples, the method illustrated in FIG. 1 further includes: storing series indexes and TSIs corresponding to the data in the CXL memory based on the data corresponding to the read request being found in the disk.

According to embodiments of the present disclosure, since the series index and the TSIs corresponding to data are stored into the CXL memory, when the data is read at the next time, the indexes corresponding to the data may be quickly found in the CXL memory, thereby increasing the speed of reading the data.

In one or more examples, the index data in the CXL memory may be evicted by a Least Recently Used (LRU) algorithm.

In one or more examples, index data with the earliest time range in the CXL memory may be preferentially deleted.

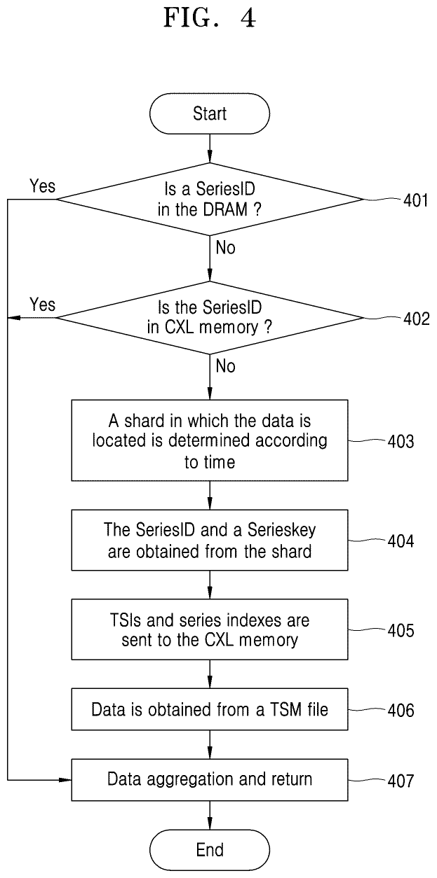

FIG. 4 illustrates a flowchart of a process of reading data from InfluxDB according to one or more embodiments of the present disclosure.

Referring to FIG. 4, at operation S401, it is determined whether a SeriesID corresponding to a read request is in the host memory (e.g., a DRAM). If the SeriesID is in the host memory, the process proceeds to operation S407, otherwise the process proceed to operation S402.

At operation S402, it is determined whether the SeriesID corresponding to the read request is in the CXL memory. If the SeriesID is in the CXL memory of the CXL-PNM device, the process proceeds to operation S407, otherwise the process proceeds to operation S403.

At operation S403, a shard in which the data to be read corresponding to the read request is located is determined based on time information included in the read request.

At operation S404, the SeriesID and a Series key are obtained from the determined shard.

At operation S405, TSIs and series indexes corresponding to the data that are read are sent to the CXL memory by the host.

At operation S406, the data is read from a TSM file of the determined shard.

At operation S407, data aggregation is performed and the data is returned.

According to embodiments of the present disclosure, in the process of looking up a key by the SeriesID, if the key is not hit in the memory, the full amount of data on the disk needs to be traversed. According to embodiments of the present disclosure, the data look-up range may be narrowed down due to the fact that the series files are stored according to the shards, thereby increasing the speed of data reading.

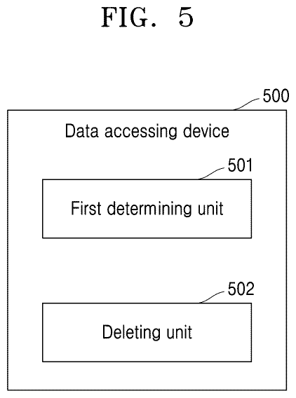

The data accessing methods for InfluxDB according to embodiments of the present disclosure are described with reference to FIGS. 1 to 4 in the above. A data accessing device for InfluxDB according to embodiments of the present disclosure is described below with reference to FIG. 5.

FIG. 5 illustrates a block diagram of a structure of a data accessing device for InfluxDB 500 according to embodiments of the present disclosure.

Referring to FIG. 5, the data access device 500 may include a first determining unit 501 and a deleting unit 502.

It should be appreciated by those skilled in the art that the data accessing device 500 may additionally include other components, and at least one of the components included in the data accessing device 500 may be combined or divided.

In one or more examples, the first determining unit 501 may be configured to determine whether usage amount for a host memory exceeds a first threshold.

In one or more examples, the deleting unit 502 may be configured to delete in-memory indexes in the host memory having an earliest time range based on determining that the usage amount for the host memory exceeds the first threshold.

In one or more examples, the data accessing device 500 further includes: a second determining unit configured to determine whether series indexes and time series indexes (TSIs) corresponding to the in-memory indexes exist in a disk based on determining that the usage amount for the host memory exceeds the first threshold; and a CXL-PNM unit configured to generate the series indexes and the TSIs corresponding to the in-memory indexes and store the generated series indexes and TSIs in the disk based on determining that the series indexes and the TSIs corresponding to the in-memory indexes do not exist in the disk.

In one or more examples, the first determining unit 501 is further configured to determine whether the usage amount for the host memory is less than a second threshold.

In one or more examples, the deleting unit 502 is further configured to reload in-memory indexes that were recently deleted from the host memory into the host memory based on determining that the usage amount for the host memory is less than the second threshold.

In one or more examples, the deleting unit 502 is configured to: determine a difference between a deletion time for the in-memory indexes that were recently deleted from the host memory and a current time; and reload the memory indexes that were recently deleted from the host memory into the host memory based on determining that the difference is greater than a third threshold.

In one or more examples, the data accessing device 500 further includes: a rebuilding unit configured to rebuild the indexes of a current shard into the host memory and rebuild indexes of a non-current shard into a CXL memory of the CXL-PNM unit when the InfluxDB is restarted.

In one or more examples, the CXL-PNM unit is further configured to perform compaction on TSM files that need to be compacted in the InfluxDB when the TSM files needs to be compacted. For example, it may be determined that a TSM file may need to be compacted (e.g., compressed) when a size of the TSM file exceeds a size threshold.

In one or more examples, the data accessing device 500 further includes: a sending unit configured to send the TSM files to the CXL memory of the CXL-PNM unit, and the CXL-PNM is configured to perform compaction on the TSM files in the CXL memory by a PNM engine of the CXL-PNM unit, and store the compacted TSM files in the disk.

In one or more examples, each shard in the InfluxDB has a corresponding series file.

In one or more examples, the sending unit is further configured to send a series file corresponding to the each shard to a CXL-PNM unit based on determining that the series file corresponding to the each shard needs to be compacted, and the CXL-PNM unit is configured to perform compaction on the series file.

In one or more examples, the data accessing device 500 further includes a look-up unit configured to: look up an index corresponding to a read request for the InfluxDB in the host memory in response to receiving the read request; look up the index corresponding to the read request in a CXL memory of the CXL-PNM unit based on the index corresponding to the read request being not found in the host memory; and look up data corresponding to the read request in the disk based on the index corresponding to the read request being not found in the CXL memory.

In one or more examples, the data accessing device further includes a storing unit configured to store series indexes and TSIs corresponding to the data in the CXL memory based on the data corresponding to the read request being found in the disk.

According to one or more embodiments of the present disclosure, there may be provided a computer-readable storage medium storing instructions, when executed by at least one processor, causing the at least one processor to perform the data accessing method for the InfluxDB according to the present disclosure. Examples of computer-readable storage media here include: read only memory (ROM), random access programmable read only memory (PROM), electrically erasable programmable read only memory (EEPROM), random access memory (RAM), dynamic random access memory (DRAM), static random access memory (SRAM), flash memory, non-volatile memory, CD-ROM, CD-R, CD+R, CD-RW, CD+RW, DVD-ROM, DVD-R, DVD+R, DVD-RW, DVD+RW, DVD-RAM, BD-ROM, BD-R, BD-R LTH, BD-RE, Blu-ray or optical disc storage, hard disk drive (HDD), solid state Hard disk (SSD), card storage (such as multimedia card, secure digital (SD) card or extreme digital (XD) card), magnetic tape, floppy disk, magneto-optical data storage device, optical data storage device, hard disk, solid state disk and any other devices configured to store computer programs and any associated data, data files, and data structures in a non-transitory manner, and provide the computer programs and any associated data, data files, and data structures to the processor or the computer, so that the processor or the computer can execute the computer program. The computer program in the above-mentioned computer-readable storage medium may run in an environment deployed in computing equipment such as a client, a host, an agent device, a server, etc. In addition, in one example, the computer program and any associated data, data files and data structures are distributed on networked computer systems, so that computer programs and any associated data, data files, and data structures are stored, accessed, and executed in a distributed manner through one or more processors or computers.

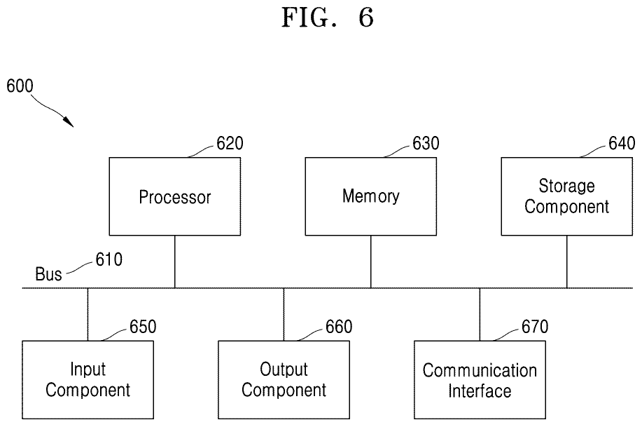

FIG. 6 is a block diagram of an example computer system, in accordance with embodiments of the present disclosure.

FIG. 6 is a block diagram of example components of one or more devices of FIG. 1. The device 600 may correspond to the data accessing device 500 (FIG. 5). As shown in FIG. 6, the device 600 may include a bus 610, a processor 620, a memory 630, a storage component 640, an input component 650, an output component 660, and a communication interface 670.

The bus 610 includes a component that permits communication among the components of the device 600. The processor 620 is implemented in hardware, firmware, or a combination of hardware and software. The processor 620 is a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), or another type of processing component. In some implementations, the processor 620 includes one or more processors capable of being programmed to perform a function. The memory 630 includes a random access memory (RAM), a read only memory (ROM), and/or another type of dynamic or static storage device (e.g. a flash memory, a magnetic memory, and/or an optical memory) that stores information and/or instructions for use by the processor 620.

The storage component 640 stores information and/or software related to the operation and use of the device 600. For example, the storage component 640 may include a hard disk (e.g. a magnetic disk, an optical disk, a magneto-optic disk, and/or a solid state disk), a compact disc (CD), a digital versatile disc (DVD), a floppy disk, a cartridge, a magnetic tape, and/or another type of non-transitory computer-readable medium, along with a corresponding drive.

The input component 650 includes a component that permits the device 600 to receive information, such as via user input (e.g. a touch screen display, a keyboard, a keypad, a mouse, a button, a switch, and/or a microphone). Additionally, or alternatively, the input component 650 may include a sensor for sensing information (e.g. a global positioning system (GPS) component, an accelerometer, a gyroscope, and/or an actuator). The output component 660 includes a component that provides output information from the device 600 (e.g. a display, a speaker, and/or one or more light-emitting diodes (LEDs)).

The communication interface 670 includes a transceiver-like component (e.g., a transceiver and/or a separate receiver and transmitter) that enables the device 600 to communicate with other devices, such as via a wired connection, a wireless connection, or a combination of wired and wireless connections. The communication interface 670 may permit the device 600 to receive information from another device and/or provide information to another device. For example, the communication interface 670 may include an Ethernet interface, an optical interface, a coaxial interface, an infrared interface, a radio frequency (RF) interface, a universal serial bus (USB) interface, a Wi-Fi interface, a cellular network interface, or the like.

The device 600 may perform one or more processes described herein. The device 600 may perform these processes in response to the processor 620 executing software instructions stored by a non-transitory computer-readable medium, such as the memory 630 and/or the storage component 640. A computer-readable medium is defined herein as a non-transitory memory device. A memory device includes memory space within a single physical storage device or memory space spread across multiple physical storage devices.

Software instructions may be read into the memory 630 and/or the storage component 640 from another computer-readable medium or from another device via the communication interface 670. When executed, software instructions stored in the memory 630 and/or the storage component 640 may cause the processor 620 to perform one or more processes described herein. Additionally, or alternatively, hardwired circuitry may be used in place of or in combination with software instructions to perform one or more processes described herein. Thus, implementations described herein are not limited to any specific combination of hardware circuitry and software.

The number and arrangement of components shown in FIG. 6 are provided as an example. In practice, the device 600 may include additional components, fewer components, different components, or differently arranged components than those shown in FIG. 6. Additionally, or alternatively, a set of components (e.g. one or more components) of the device 600 may perform one or more functions described as being performed by another set of components of the device 600.

According to one or more embodiments of the present disclosure, there may be provided a computer program product, wherein instructions in the computer program product may be executed by a processor of a computer device to implement the data accessing method for InfluxDB described herein.

Those skilled in the art will easily think of other embodiments of the present disclosure after considering the specification and practicing the disclosure disclosed herein. The present disclosure is intended to cover any variations, uses, or adaptive changes of the present disclosure. These variations, uses, or adaptive changes follow the general principles of the present disclosure and include common knowledge or conventional technical means in the technical field that are not disclosed in the present disclosure. The specification and the embodiments are to be regarded as exemplary only, and the actual scope and spirit of the present disclosure are pointed out by the following claims.

1. A data accessing method for a time series database, comprising:
determining, by a host apparatus, whether a usage amount for a host memory exceeds a first threshold; and
deleting, by the host apparatus, one or more in-memory indexes having an earliest time range in the host memory based on determining that the usage amount for the host memory exceeds the first threshold.

2. The data accessing method of claim 1, further comprising:
determining, by the host apparatus, whether one or more series indexes and one or more time series indexes (TSIs) corresponding to the one or more in-memory indexes exist in a disk based on determining, by the host apparatus, that the usage amount for the host memory exceeds the first threshold; and
generating, by a Compute Express Link Processing-Near-Memory (CXL-PNM) circuit, the one or more series indexes and the one or more TSIs corresponding to the one or more in-memory indexes and storing the generated one or more series indexes and the one or more TSIs in the disk based on determining that the one or more series indexes and the one or more TSIs corresponding to the one or more in-memory indexes do not exist in the disk.

3. The data accessing method of claim 1, further comprising:
determining, by the host apparatus, whether the usage amount for the host memory is less than a second threshold; and
reloading, by the host apparatus, the one or more in-memory indexes that were recently deleted from the host memory into the host memory based on determining that the usage amount for the host memory is less than the second threshold,
wherein the second threshold is greater than the first threshold.

4. The data accessing method of claim 3, wherein the reloading of the one or more in-memory indexes that were recently deleted from the host memory into the host memory further comprises:
determining, by the host apparatus, a difference between a deletion time for the one or more in-memory indexes that were recently deleted from the host memory and a current time; and
reloading, by the host apparatus, the one or more in-memory indexes that were recently deleted from the host memory into the host memory based on determining that the difference between the deletion time and the current time is greater than a third threshold.

5. The data accessing method of claim 2, further comprising:
rebuilding, by the host apparatus, one or more indexes of a current shard into the host memory and rebuilding one or more indexes of a non-current shard into a Computer Express Link (CXL) memory of the CXL-PNM circuit based on determining the time series database is restarted.

6. The data accessing method of claim 1, further comprising: performing, by the CXL-PNM circuit, compression of one or more time structured merge tree (TSM) files in the time series database based on determining a size of a respective TSM file exceeds a threshold.

7. The data accessing method of claim 6, wherein the performing of compressing the one or more TSM files by the CXL-PNM circuit comprises:
sending the one or more TSM files to a CXL memory of the CXL-PNM circuit by the host apparatus, performing compressing of the one or more TSM files in the CXL memory by a Processing-Near-Memory (PNM) engine of the CXL-PNM circuit; and
storing the compressed one or more TSM files in a disk by the CXL-PNM circuit.

8. The data accessing method of claim 1, wherein each shard in the time series database has a corresponding series file.

9. The data accessing method of claim 8, further comprising:
sending a series file corresponding to the each shard to a CXL-PNM circuit by the host apparatus based on determining that a size of the series file corresponding to each shard exceeds a size threshold; and
performing compression on the series file by the CXL-PNM circuit.

10. The data accessing method of claim 2, further comprising:
looking up an index corresponding to a read request for the time series database in the host memory in response to receiving the read request;
looking up the index corresponding to the read request in a CXL memory of the CXL-PNM circuit based on determining that the index corresponding to the read request is not found in the host memory; and
looking up data corresponding to the read request in the disk based on determining the index corresponding to the read request is not found in the CXL memory.

11. The data accessing method of claim 10, further comprising: storing the one or more series indexes and the one or more TSIs corresponding to the data in the CXL memory based on determining that the data corresponding to the read request is found in the disk.

12. A data accessing device for a time series database, comprising:
a memory configured to store one or more instructions; and
a processor operatively coupled to the memory and configured to execute the one or more instructions stored in the memory,
wherein the one or more instructions, when executed by the processor, cause the data accessing device to:
determine whether a usage amount for a host memory exceeds a first threshold, and
delete one or more in-memory indexes having an earliest time range in the host memory based on determining that the usage amount for the host memory exceeds the first threshold.

13. The data accessing device of claim 12, wherein the one or more instructions, when executed by the processor, cause the data accessing device to:
determine whether one or more series indexes and one or more time series indexes (TSIs) corresponding to the one or more in-memory indexes exist in a disk based on determining that the usage amount for the host memory exceeds the first threshold, and
generate the one or more series indexes and the one or more TSIs corresponding to the one or more in-memory indexes and store the generated one or more series indexes and the one or more TSIs in the disk based on determining that the one or more series indexes and the one or more TSIs corresponding to the one or more in-memory indexes do not exist in the disk.

14. The data accessing device of claim 12, wherein the one or more instructions, when executed by the processor, cause the data accessing device to:
determine whether the usage amount for the host memory is less than a second threshold, and
reload the one or more in-memory indexes that were recently deleted from the host memory into the host memory based on determining that the usage amount for the host memory is less than the second threshold,
wherein the second threshold is greater than the first threshold.

15. The data accessing device of claim 14, wherein the one or more instructions, when executed by the processor, cause the data accessing device to:
determine a difference between a deletion time for the one or more in-memory indexes that were recently deleted from the host memory and a current time, and
reload the one or more in-memory indexes that were recently deleted from the host memory into the host memory based on determining that the difference between the deletion time and the current time is greater than a third threshold.

16. The data accessing device of claim 13, wherein the one or more instructions, when executed by the processor, cause the data accessing device to:
rebuild one or more indexes of a current shard into the host memory and rebuild one or more indexes of a non-current shard into a Computer Express Link (CXL) memory of a Computer Express Link Processing-Near-Memory (CXL-PNM) circuit based on determining the time series database is restarted.

17. The data accessing device of claim 12, wherein the one or more instructions, when executed by the processor, cause the data accessing device to:
perform compression of one or more time structured merge tree (TSM) files that need to be compacted in the time series database based on determining a size of the one or more TSM files exceeds a threshold.

18. The data accessing device of claim 17, wherein the one or more instructions, when executed by the processor, cause the data accessing device to:
send the one or more TSM files to the CXL memory of the CXL-PNM circuit,
wherein the CXL-PNM circuit is configured to perform compression on the one or more TSM files in a CXL memory by a PNM engine of the CXL-PNM circuit, and store the compressed one or more TSM files in the disk.

19. The data accessing device of claim 12, wherein each shard in the time series database has a corresponding series file.

20. (canceled)

21. (canceled)

22. (canceled)

23. A non-transitory computer readable medium having instructions stored therein, which when executed by a processor, cause the processor to execute a method comprising:
determining, by a host apparatus, whether a usage amount for a host memory exceeds a first threshold; and
deleting, by the host apparatus, one or more in-memory indexes having an earliest time range in the host memory based on determining that the usage amount for the host memory exceeds the first threshold.
